(19) United States
(12) Patent Application Publication
(10) Pub. No.: US 2003/0191240 A1
(43) Pub. Date: Oct. 9, 2003

(54) Copolymers for optical data storage

(76) Inventors: Horst Berneth, Leverkusen (DE); Thomas Bieringer, Odenthal (DE); Rainer Hagen, Leverkusen (DE); Serguei Kostromine, Swisttal (DE)

Correspondence Address: BAYER POLYMERS LLC, 100 BAYER ROAD, PITTSBURGH, PA, 15205, US

(21) Appl. No.: 10/296,683

(22) PCT Filed: May 18, 2001
(86) PCT No.: PCT/EP01/05709

(30) Foreign Application Priority Data
May 31, 2000 (DE) 100 27 152.9

(51) Int. Cl. C08G 2/00

(52) U.S. Cl. 525/50

(57) ABSTRACT

The invention relates to copolymers for optical data storage.

The invention relates to mixed polymers and the use of the latter for optical data storage.

Photoaddressable polymers are known (Polymers as electrooptical and fotooptical active media, V. P. Shibaev (ed.), Springer Verlag, New York 1995). Particularly suitable for this purpose are side-group polymers, of which the group of the copolymers is distinguished by very wide possibilities in the variation of the properties. Their special peculiarity is that their optical properties such as absorption, emission, reflection, birefringence, scatter may be changed reversibly by light induction. Polymers of this kind have a particular comb-like structure: on a linear spine sit—connected by molecule parts acting as spacers—side groups which may absorb electromagnetic radiation. Examples of this kind are dye molecules, in particular the side-group polymers containing azobenzene groups according to U.S. Pat. No. 5,173,381. Said substances are characterised by the capacity to form a directional birefringence when irradiated with polarised light. The inscribed birefringence patterns may be made visible in the polarised light.

It is furthermore known that there may be inscribed in layers of said polymers at any point with polarised light a locally limited birefringence whose main axis moves in sympathy on the rotation of the polarising direction (K. Anderle, R. Birenheide, M. Eich, J. H. Wendorff, Makromol. Chem., Rapid Commun. 10, 477-483 (1989), J. Stumpe et al., 20th Freiburg Working Conference on Liquid Crystals 1991).

Suitable in principle for the production of the photoaddressable substrate are all polymers into which a directional birefringence may be inscribed (Polymers as electrooptical and fotooptical active media, V. P. Shibaev (ed.), Springer Verlag, New York 1995; Natansohn et al., Chem. Mater. 1993, 403-411). These are in particular side-group polymers, of which the copolymers are preferred. Preferred such copolymers are disclosed for example in DE-A 43 10 368 and DE-A 44 34 966. Preferably, they contain a poly(meth)acrylate main chain acting as a spine with recurring units,

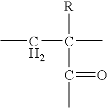

wherein R represents hydrogen or methyl, the dots indicate the linkage of the further units of the main chain and the side chain is linked to the carbonyl group.

From DE-A-19 620 588 are known polymers which contain side chains branching off from the main chain and having the formulae -S-T-Q-P with P=A, M:

-S¹-T¹-Q¹-A (I) and

-S²-T²-Q²-M (II),

wherein

S¹, S² signify independently of one another the atoms O, S or the group NR¹,

R¹ signifies hydrogen or C₁-C₄ alkyl,

T¹, T² signify independently of one another the group (CH₂)ₙ, which optionally may be interrupted by —O—, —NR¹— or —OSiR¹₂O— and/or substituted by methyl or ethyl, and

n signifies the numbers 2, 3 or 4,

Q¹, Q² a divalent group,

A a unit which may absorb electromagnetic radiation and

M a polarisable aromatic group having at least 12 π-electrons.

The function of M is co-operative re-orientation together with the actual absorbing units. This results in a strengthening of the re-orientation and stabilisation of the re-oriented molecules.

Particularly preferred are polymers in which

Q¹, Q² signify independently of one another Z¹, Z² or the group -Z¹-X-Z², wherein

Z¹, Z² signify independently of one another the groups —S—, —SO₂—, —O—, —COO—, —OCO—, —CONR¹—, —NR¹CO—, —NR¹—, —N═N—, —CH═CH—, —N═CH—, —CH═N— or the group —(CH₂)ₘ— with m=1 or 2 and

X signifies a 5- or 6-member cycloaliphatic, aromatic or heterocyclic ring, for the case Z¹=—COO— or —CONR¹— a direct link or the group 4CH═CH)ₘ—, where m has the meaning given above,

A signifies the residue of a mono-azo dye which absorbs in the wavelength range between 650 and 340 nm, and

M signifies the residue of a polarised and further polarisable aromatic, linearly structured system having at least 12 π-electrons.

Preferred groups A correspond to the formula

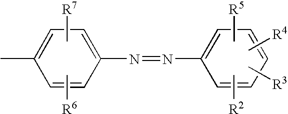

where

R² to R⁷ signify independently of one another hydrogen, hydroxyl, halogen, nitro, cyano, C₁-C₄-alkyl, C₁-C₄-alkoxy, CF₃, CCl₃, CBr₃, SO₂CF₃, C₁-C₆-alkylsulfonyl, phenylsulfonyl, C₁-C₆-alkylaminosulfonyl, phenylaminosulfonyl, aminocarbonyl, C₁-C₆-alkylaminocarbonyl, phenylaminocarbonyl or COOR¹.

Preferred groups M correspond to the formula

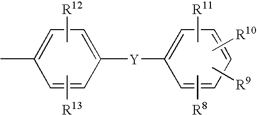

where

R⁸ to R¹³ signify independently of one another hydrogen, hydroxyl, halogen, nitro, cyano, C₁-C₄-alkyl, C₁-C₄-alkoxy, CF₃, CCl₃, CBr₃, SO₂CF₃, C₁-C₆-alkylsulfonyl, phenylsulfonyl, C₁-C₆-alkylaminosulfonyl, phenylaminosulfonyl, aminocarbonyl, C₁-C₆-alkylaminocarbonyl, phenylaminocarbonyl or COOR¹ and

Y signifies —COO—, —OCO—, —CONH—, —NHCO—, —O—, —NH—, —N(CH₃)— or a single bond.

Amorphous polymers are preferred, i.e. ones which do not form macroscopically discernible liquid crystalline phases. “Amorphous” means an optically isotropic state. Such polymers neither scatter visible light nor possess a birefringence in the initial isotropic state without the action of external forces.

A process for producing the radical polymerisation is likewise mentioned.

Materials for holographic data storage are likewise known.

Holography is a process in which, through the interference of two coherent beams of light (signal wave and reference wave), objects may be imaged in suitable storage materials and said images may be read out again with light (reading beam) (D. Gabor, Nature 151, 454 (1948), N. H. Farath, Advances in holography, Vol. 3, Marcel Decker (1977), H. M. Smith, Holographic recording materials, Springer (1977). By changing the angle between signal and reference wave on the one hand and the holographic storage material on the other, numerous holograms may be inscribed into the material and finally also read out again individually. As a rule the light of a laser serves as a coherent light source. Many different materials are disclosed as storage material, e.g. inorganic crystals such as LiNbO₃ (e.g.), organic polymers (e.g. M. Eich, J. H. Wendorff, Makromol. Chem., Rapid Commun. 8, 467 (1987), J. H. Wendorff, M. Eich, Mol. Cryst. Liq. Cryst. 169, 133 (1989)) or Fotopolymere (Uh-Sock Rhee et al., Applied Optics, 34 (5), 846 (1995)).

Said materials, however, still do not meet all the requirements of a holographic recording medium. In particular they do not possess adequate stabilities of the inscribed hologram. Multiple inscription is possible to only a limited extent as a rule, since with the inscription of a new hologram the hologram already inscribed is overwritten and hence erased. This applies in particular to inorganic crystals, which are subjected to a complex heat treatment in order to compensate for said stability problems. Photopolymers conversely exhibit the problem of shrinkage, which has a negative effect on the holographic imaging properties.

Materials with high stability of the inscribed holograms are likewise known, e.g. from EP-A 0 704 513.

The high optical density of said materials does not however permit the production of high-volume holographic stores, such as are required for the storage of numerous holograms in a storage material.

There was therefore a requirement for a material which is suitable for the production of sufficiently thick high-volume holographic stores. The thickness of the materials should lie in the range of millimetres. With the materials of the prior art, the penetration of the laser beams almost always presents problems by virtue of the high optical density.

The object was an avoidance of this problem with simultaneous guaranteeing of the high storage efficiency. It can be observed that with increasing dilution of the dyes in copolymers (decrease in the optical density) a decrease in the holographic diffraction efficiency is also to be observed.

Surprisingly it has now been found that mixtures of polymers with specific chemical architectures are possible and do not exhibit said disadvantage.

The present application therefore provides a mixed polymer characterised in that it consists of

at least one polymer (A) having at least 10 repeat units with the general formula (CI)

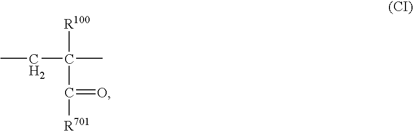

where

R¹⁰⁰ represents hydrogen or methyl and

R⁷⁰¹ for —O—R⁸⁰¹, where

R⁸⁰¹ represents hydrogen or C₁-C₈ linear or branched-chain alkyl without photoisomerisable groups, preferably methyl, ethyl, propyl, n-butyl, particularly preferably methyl, and

at least one polymer (B) having at least 3 repeat units with the general formula (CII)

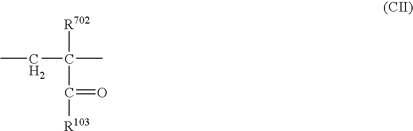

where

R⁷⁰² represents hydrogen or methyl and

R¹⁰³ for [-S-T-Q-P] and where P represents A and/or M,

where however a polymer (B) is always contained in which P represents A.

The side-chains branching off from the main chain, of the formula S-T-Q-P with P=A (dye group), M (mesogen), are governed by the following definitions:

S-T-Q-P=S¹-T¹-Q¹-A

S-T-Q-P=S²-T²-Q²-M

where

S¹, S² signify independently of one another the atoms O, S or the group NR¹,

R¹ signifies hydrogen or C₁-C₄ alkyl,

T¹, T² signify independently of one another the group (CH₂)ₙ, which may optionally be interrupted by —O—, —NR¹— or —OSiR¹₂O— and/or substituted by methyl or ethyl,

n signifies the numbers 2, 3 or 4,

Q¹, Q² a divalent group,

A a unit which may absorb electromagnetic radiation and

M a polerisable aromatic group having at least 12 π-electrons.

The function of M is co-operative re-orientation together with the actual absorbing units. This results in a strengthening of the re-orientation and stabilisation of the re-oriented molecules.

Particularly preferred are polymers in which

Q¹, Q² signify independently of one another Z¹, Z² or the group -Z¹-X-Z²-, where

Z¹, Z² signify independently of one another the groups —S—, —SO₂, —O—, —COO—, —OCO—, —CONR¹—, —NR¹CO—, —NR¹—, —N═N, —CH═CH—, —N═CH—, —CH═N— or the group —(CH₂)ₘ— with m=1 or 2 and

X signifies a 5- or 6-member cycloaliphatic, aromatic or heterocyclic ring, for the case Z¹=—COO— or —CONR¹— a direct bond or the group —(CH═CH)ₘ—, where m has the meaning given above,

A signifies the residue of a mono-azo dye which absorbs in the wavelength range between 650 and 340 nm and

M the residue of a polarised and farther polymerisable aromatic, linearly structured system having at least 12 π-electrons.

Preferred A groups correspond to the formula

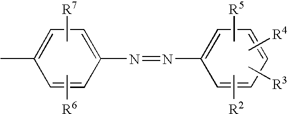

where

R² to R⁷ signify independently of one another hydrogen, hydroxyl, halogen, nitro, cyano, C₁-C₄ alkyl, C₁-C₄ alkoxy, CF₃, CCl₃, CBr₃, SO₂CF₃, C₁-C₆-alkylsulfonyl, phenylsulfonyl, C₁-C₆-alkylaminosulfonyl, phenylaminosulfonyl, aminocarbonyl, C₁-C₆-alkylaminocarbonyl, phenylaminocarbonyl or COOR¹.

Preferred M groups correspond to the formula

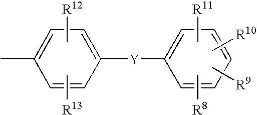

where

R⁸ to R¹³ signify independently of one another hydrogen, hydroxyl, halogen, nitro, cyano, C₁-C₄ alkyl, C₁-C₄ alkoxy, CF₃, CCl₃, CBr₃, SO₂CF₃, C₁-C₆ alkylsulfonyl, phenylsulfonyl, C₁-C₆-alkylaminosulfonyl, phenylaminosulfonyl, aminocarbonyl, C₁-C₆-alkylaminocarbonyl, phenylaminocarbonyl or COOR¹ and

Y signifies —COO—, —OCO—, —CONH—, —NHCO—, —O—, —NH—, —N(CH₃)— or a single bond.

Particularly good results are obtained if there are contained in the polymer (A) at least 10, preferably at least 20, particularly preferably at least 30, most preferably of all at least 50 repeat units.

A plurality of repeat units should also be present in the polymer (B), at least 3, preferably at least 5, particularly preferably at least 10 and most preferably of all at least 20 repeat units are contained.

Particularly preferred are mixtures of polymer A and polymer B, wherein polymer A is composed uniformly of identical monomer units and polymer B is likewise composed of monomer units which are identical (but different from A according to the above definition).

Naturally it is also included by the present invention that more than 1 polymer (A) and/or (B) is contained, wherein however a polymer (B) is always contained in which P represents A.

Very good results are obtained if the ratio of the sum of the monomers of the polymers (B) to the sum of the monomers of the polymers (A) lies between 1:1 and 1:10 000, preferably between 1:1 and 5000, particularly preferably between 1:2 and 1:3000, very particularly preferably between 1:5 and 1:1500 and most preferably of all between 1:10 and 1:1000.

Preferred are mixed polymers in which the polymer (A) contains methyl methacrylate units.

Good results are achieved when polymers (B) having elements which bear STQP are present. An improved embodiment consists in polymer B containing at least 2 different monomers which bear the general formula [STQP], wherein at least one of said monomers bears a dye group A, preferably a photoisomerisable group. It is further particularly preferable that said photoisomerisable group is an azo group.

Most particularly preferably said group has the structure of the formula (CIV).

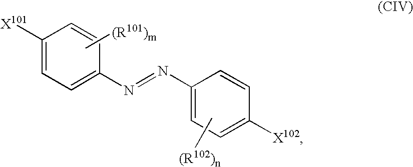

where

R¹⁰¹ and R¹⁰² represent independently of one another hydrogen or a nonionic substituent,

m and n represent independently of one another a whole number from 0 to 4, preferably 0 to 2,

X¹⁰¹ represents the linkage with S¹⁰¹T¹⁰¹Q¹⁰¹, i.e. X¹⁰¹ has the meaning X¹⁰¹, where X¹⁰¹ is linked to the Q with the 2nd valency,

X¹⁰² signifies X¹⁰²—R¹⁰⁴,

X^{101′} and X^{102′} represent a direct bond, —O—, —S—, —(N—R¹⁰⁵)—, —C(R¹⁰⁶ R¹⁰⁷)—, —(C═O)—, —(CO—O)—, —(CO—NR¹⁰⁵)—, —(SO₂)—, —(SO₂—O)—, —(SO₂—NR¹⁰⁵)—, —(C═NR¹⁸)— or —CNR¹⁸—NR¹⁵)—,

R¹⁰⁴, R¹⁵ and R¹⁸ represent independently of one another hydrogen, C₁- to C₂₀-alkyl, C₃- to C₁₀-cycloalkyl, C₂- to C₂₀-alkenyl, C₆-C₁₀-aryl, C₁-C₂₀-alkyl-(C═O)—, C₃- to C₁₀-cycloalkyl-(C═O)—, C₂- to C₂₀-alkenyl-(C═O)—, C₆- to C₁₀-aryl-(C═O)—, C₁- to C₂₀-alkyl-(SO₂)—, C₃- to C₁₀-cycloalkyl-(SO₂)—, C₂- to C₂₀-alkenyl-(SO₂)— or C₆- to C₁₀-aryl-(SO₂)— or

X^{102′}—R¹⁰⁴ may represent hydrogen, halogen, cyano, nitro, CF₃ or CCl₃,

R¹⁰⁶ and R¹⁰⁷ represent independently of one another hydrogen, halogen, C₁- to C₂₀-alkyl, C₁- to C₂₀-alkoxy, C₃- to C₁₀-cycloalkyl, C₂- to C₂₀-alkenyl or C₆- to C₁₀-aryl,

S¹⁰¹ signifies the atoms O, S or the group NR¹⁰⁹,

R¹⁰⁹ signifies hydrogen or C₁-C₄-alkyl,

T¹⁰¹ signifies the group (CH₂)ₓ, which may optionally be interrupted by —O—, —NR¹⁰⁹- or —OSiR¹⁰⁹₂O— and/or substituted by methyl or ethyl,

x signifies the numbers 2, 3 or 4,

Q¹⁰¹ signifies Z¹⁰¹, Z¹⁰² or the group -Z¹⁰¹-X¹⁰⁰-Z¹⁰²-, where

Z¹⁰¹ and Z¹⁰² signify independently of one another the groups —S—, —SO₂—, —O— —COO—, —OCO—, —CONR¹⁰⁹—, —NR¹⁰⁹CO—, —NR¹⁰⁹—, —N═N—, —CH═CH—, —N═CH—, —CH═N— or the group —(CH₂)_{y}— with y=1 or 2 and

X¹⁰⁰ signifies a 5- or 6-member cycloaliphatic, aromatic or heterocyclic ring, for the case Z¹⁰¹=—COO— or —CONR¹⁰⁹— a direct bond or the group —(CH═CH)_{y}—,

where y has the meaning given above.

By nonionic substituents are to be understood halogen, cyano, nitro, C₁- to C₂₀-alkyl, C₁- to C₂₀-alkoxy, phenoxy, C₃- to C₁₀-cycloalkyl, C₂- to C₂₀-alkenyl or C₆- to C₁₀-aryl, C₁- to C₂₀-alkyl-(C═O)—, C₆- to C₁₀-aryl-(C═O)—, C₁- to C₂₀-alkyl-(SO₂)—, C₁- to C₂₀-alkyl-(C═O)—O—, C₁- to C₂₀-alkyl-(C═O)—NH—, C₆- to C₁₀-aryl-(C═O)—NH—, C₁- to C₂₀-alkyl-O—(C═O)—, C₁- to C₂₀-alkyl-NH—(C═O)— or C₆- to C₁₀-aryl-NH—(C═O)—.

The alkyl, cycloalkyl, alkenyl and aryl groups may for their part be substituted by up to 3 groups from the series halogen, cyano, nitro, C₁- to C₂₀-alkyl, C₁- to C₂₀-alkoxy, C₃- to C₁₀-cycloalkyl, C₂- to C₂₀-alkenyl or C₆- to C₁₀-aryl and the alkyl and alkenyl groups may be straight-chain or branched.

By halogen is to be understood fluorine, chlorine, bromine and iodine, in particular fluorine and chlorine.

Preferred are mixed polymers characterised in that the monomers with the photoisomerisable group A exhibit the formula (CV)

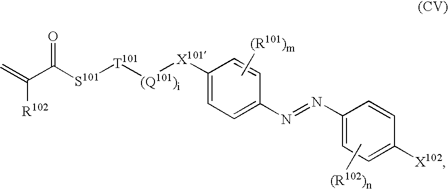

where

R¹⁰² represents hydrogen or methyl and

the other groups possess the meanings given above.

Particularly preferred monomers which bear the photoisomerisable group A are:

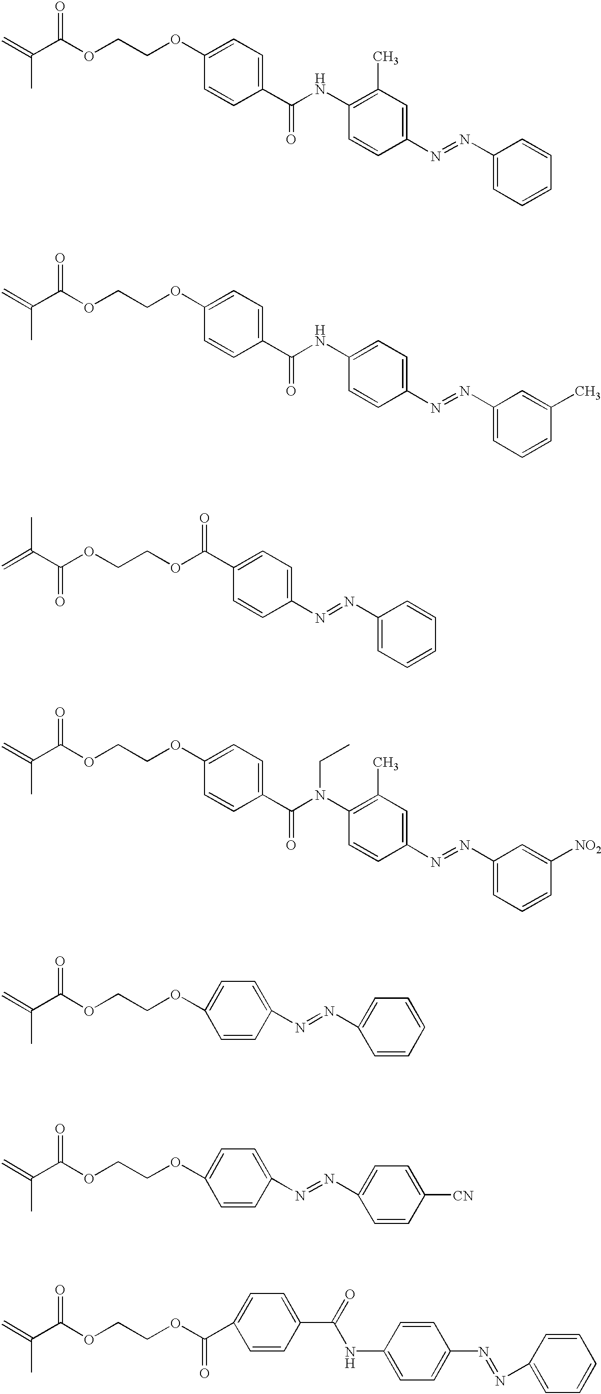

Likewise preferred are mixed polymers characterised in that they contain, in addition to monomers having the photoisomerisable group A, preferably those with the formula (CV), monomers having the polarisable aromatic group M with the formula (CVI)

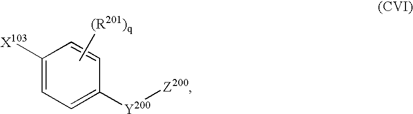

where

Z²⁰⁰ represents a group with the formulae

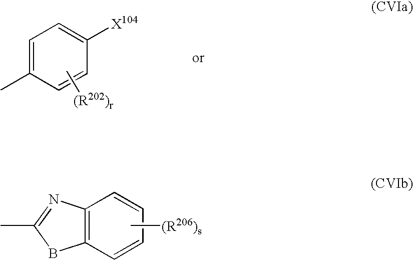

where

B represents O, S or N—C₁- to C₄-alkyl,

X¹⁰³ represents —X^{103′}-(Q¹⁰²)ⱼ-T¹⁰²-S¹⁰²—,

X¹⁰⁴ represents X^{104′}—R²⁰³,

X^{103′} and X^{104′} represent independently of one another a direct bond, —O—, —S—, —(N—R²⁰⁵), —C(R²⁰⁶R²⁰⁷), —(C═O)—, —(CO—O)—, —(CO—NR²⁰⁵)—, —(SO₂)—, —(SO₂—O—)—, —(SO₂—NR²⁰⁵)—, —(C═NR²⁰⁸)— or —(CNR²⁰⁸—NR²⁰⁵)—,

R²⁰⁵, R²⁰⁸ and R²⁰³ represent independently of one another hydrogen, C₁- to C₂₀-alkyl, C₃- to C₁₀-cycloalkyl, C₂- to C₂₀-alkenyl, C₆-C₁₀-aryl, C₁-C₂₀-alkyl-(C═O)—, C₃-C₁₀-cycloalkyl-(C═O)—, C₂-C₂₀-alkenyl-(C═O)—, C₆- to C₁₀-aryl-(C═O)—, C₁- to C₂₀-alkyl-(SO₂)—, C₃- to C₁₀-cycloalkyl-(SO)—, C₂- to C₂₀-alkenyl-(SO₂)— or C₆- to C₁₀-aryl-(SO₂)— or

X^{104′}—R²⁰³ may represent hydrogen, halogen, cyano, nitro, CF₃ or CCl₃,

R²⁰⁶ and R²⁰⁷ represent independently of one another hydrogen, halogen, C₁- to C₂₀-alkyl, C₁- to C₂₀-alkoxy, C₃- to C₁₀-cycloalkyl, C₂- to C₂₀-alkenyl or C₆- to C₁₀-aryl,

Y²⁰⁰ represents a single bond, —COO—, OCO—, —CONH—, —NHCO—, —CON(CH₃)—, —N(CH₃)CO—, —O—, —NH— or —N(CH₃)—,

R²⁰¹, R²⁰², R²⁰⁶ represent independently of one another hydrogen, halogen, cyano, nitro, C₁- to C₂₀-alkyl, C₁- to C₂₀-alkoxy, phenoxy, C₃- to C₁₀-cycloalkyl, C₂- to C₂₀-alkenyl or C₆- to C₁₀-aryl, C₁- to C₂₀-alkyl-(C═O)—, C₆- to C₁₀-aryl-(C═O)—, C₁- to C₂₀-alkyl-(SO₂)—, C₁-C₂₀-alkyl-(C═O)—O—, C₁- to C₂₀-alkyl-(C═O)—NH—, C₆- to C₁₀-aryl-(C═O)—NH—, C₁- to C₂₀-alkyl-O—(C═O)—, C₁- to C₂₀-alkyl-NH—(C═O)— or C₆- to C₁₀-aryl-NH—(C═O)—,

q, r and s represent independently of one another a whole number from 0 to 4, preferably 0 to 2,

Q¹⁰² represents —O—, —S—, —(N—R²⁰⁵)—, —C(R²⁰⁶R²⁰⁷)—, —(C═O)—, —(CO—O)—, —(CO—NR²⁰⁵)—, —(SO₂)—, —(SO₂—O—)—, —(SO₂—NR²⁰⁵)—, —(C═NR²⁰⁸)—, (CNR²⁰⁸—NR²⁰⁵)—, —(CH₂)ₚ—, p- or m-C₆H₄- or a divalent group with the formulae

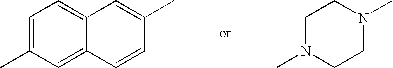

j represents a whole number from 0 to 4, where for j>1 the individual Q¹⁰² may have different meanings,

T¹⁰² represents —(CH₂)ₚ—, where the chain may be interrupted by —O—, —NR²⁰⁹- or —OSiR²²⁰₂O—,

S¹⁰² represents a direct bond, —O—, —S— or NR²⁰⁹—,

p represents a whole number from 2 to 12, preferably 2 to 8, in particular 2 to 4,

R²⁰⁹ represents hydrogen, methyl, ethyl or propyl and

R²²⁰ represents methyl or ethyl.

Preferred monomers having such groups exhibiting form anisotropy M then have the formula (CVII):

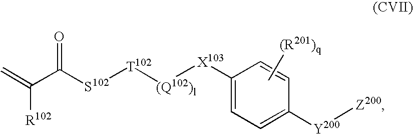

where

R¹⁰² represents hydrogen or methyl and

the other groups have the meanings given above.

Particularly preferred monomers exhibiting form anisotropy with the formula (CVII) are for example:

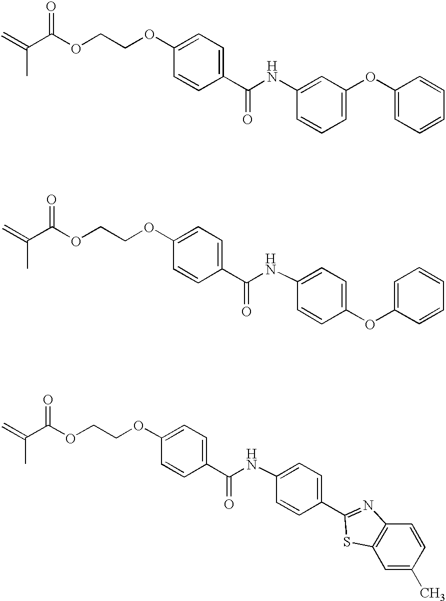

The mixed polymers according to the invention contain in addition to at least one polymer (A)

a) preferably at least one polymer (B) which consists of monomers with the formula (CV),

b) preferably at least one polymer (B) which consists of monomers with the formula (CV) and at least one polymer (B) which consists of monomers with the formula (CVII),

c) particularly preferably at least one polymer which consists of monomers with the formula (CV) and monomers with the formula (CVII).

In case a) the monomers with the formula (CV) of polymer (B) may be identical or different. The same applies to the monomers (CV) and/or (CVII) in the polymers (B) in the cases b) and c).

The monomers with the formula (CV) and the formula (CVII) are used in the mixed polymers according to the invention in the ratio 1:1 to 1:30, preferably 1:1 to 1:20, particularly preferably 1:2 to 1:10.

The polymers (A) and (B) are each produced on their own, for example by radical polymerisation. The mixed polymers are produced by mixing of the individual polymers in the desired quantitative ratios with heating to above the glass transition temperature.

An important parameter for the present invention is the optical density, which possesses for the wavelength of the writing laser and a sample thickness of 1 mm a value ≦2, preferably ≦1, particularly preferably of ≦0.3. In this way it may be ensured that the actinic light leads to a homogeneous transillumination of the entire storage medium and a thick hologram may be produced. The optical density may be determined with commercial UV/VIS spectrometers (e.g. CARY, 4G).

In particular the mixed polymer according to the invention is a material which has a transilluminated thickness of ≧0.1 mm, particularly 0.5 mm, preferably ≧1 mm and most particularly preferably not greater than 1 cm.

The grouping which interacts with the electromagnetic radiation is preferably a dye described above, which absorbs preferably in the wavelength range between 390 and 800 nm, particularly preferably around the range 400 to 650 nm and most particularly preferably in the range from 510 to 570 nm. An Nd:YAG laser (λ=532 nm) may be used as a typical test laser.

For the reading, the recording material is no longer exposed to two interfering beams, as during the writing, but only to one beam, the reading beam.

The wavelength of the reading beam is preferably longer than that of the signal and reference waves, for example 70 to 500 nm longer. Reading with the wavelength of the writing laser is however also possible and is employed in particular during the commercial use of large-volume holographic stores. In this case, however, during the reading operation the energy of the reading beam is lowered either by the reduction of the exposure intensity or the exposure time or by a reduction of the exposure intensity and the exposure time.

The optical density of the mixed polymer according to the invention is determined by the concentration of the at least one dye in the polymeric material.

### EXAMPLES

### Example 1

### Production of the Monomers

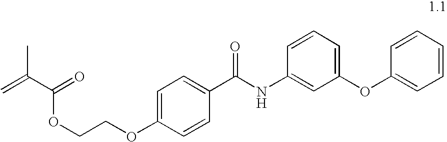

To a solution of 125 g of 4-(2-methacryloyloxy)-ethoxy-benzoic acid chloride in 200 ml dioxane are added 85.9 g of 3-aminodiphenyl ether in 200 ml dioxane, the whole is stirred for 2 h and the product is precipitated by pouring of the solution into 2 l of water. The precipitate is drawn off, dried and purified by twice repeated recrystallisation out of isopropanol. The yield amounts to 40% of theoretical. M.p.=111° C.

Ultimate analysis: C₂₅H₂₃NO₅ (417.47)

Reported: C71.93; H5.55; N3.36.

Found: C71.50; H5.70; N3.40.

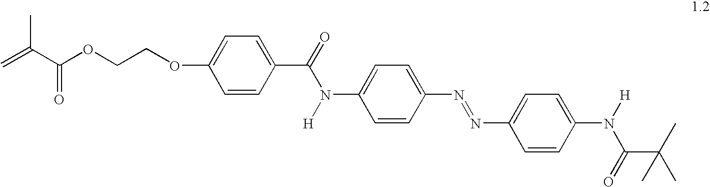

a) 4-(2-hydroxyethyloxy)benzoic Acid

138 g of p-hydroxybenzoic acid and 0.5 g of KI are placed with stirring in 350 ml of ethanol. A solution of 150 g of KOH in 150 ml of water is added drop-wise. 88.6 g of ethylene chlorohydrin are added drop-wise at 30-60° C. within 30 min. The reaction mixture is stirred for 15 h under reflux. Thereafter the solvent is distilled off completely first of all under standard pressure and then under vacuum. The residue is dissolved in 1 l of water and acidified with HCl. Precipitate is siphoned off and recrystallised out of 1.8 l of water. The product is dried and recrystallised twice out of ethanol. The yield amounts to 46 g (25% of theoretical). M.p. 179.5° C.

b) 4-(2-methacryloyloxyethyloxy)benzoic Acid

45 g of 4-(2-hydroxyethyloxy)benzoic acid, 180 ml of methacrylic acid, 10 g of p-toluolsulfonic acid and 10 g of hydroquinone are heated under reflux in 150 ml of chloroform with stirring. The water obtained during the reaction is separated on the water separator. The reaction mixture is diluted with 150 ml of chloroform, washed several times with 100 ml of water and dried over Na₂SO₄. The drying agent is filtered off, and the chloroform distilled off to two thirds on the rotary evaporator. The product precipitates, is siphoned off and recrystallised twice out of isopropanol. The yield amounts to 28 g (45% of theoretical). M.p. 146° C.

c) 4-(2-methacryloyloxyethyloxy)benzoic Acid Chloride

25 g of 4-(2-methacryloyloxyethyloxy)benzoic acid, 80 ml of thionyl chloride and 0.5 ml of DMF are stirred at room temperature for 30 min. Surplus thionyl chloride is then distilled off first of all under a moderate vacuum and than under a high vacuum. The acid chloride thereby obtained with almost quantitative yield now crystallises out slowly at room temperature

Ultimate analysis: C₁₃H₁₃ClO₄ (268.7)

Reported: C58.11; H4.88; C113.19.

Found: C58.00; H4.90; C113.20.

d) 4-pivalinoylamino-4′-aminoazobenzene

36 g of 4,4′-diaminoazobenzene and 62 g of triethylamine are placed in 400 ml of THF. A solution of 23.2 g of pivalic acid chloride in 100 ml of THF is added slowly drop-wise. After 2 hr of stirring at room temperature the reaction mixture is mixed with water. The precipitate is filtered off and dried. 42 g of the product is obtained. Further purification takes place chromatographically (silica gel; toluene/ethyl acetate 1:1). The yield amounts to 8 g. M.p. 230° C.

e) 4-pivalinoylamino-4′-[p-methacryloyloxy-ethyloxy)benzoylamino]azobenzene

1 g of 4-pivalinoylamino-4′-aminoazobenzene is placed in 10 ml of N-methyl-2-pyrrolidone (NMP) at 50° C. and added to the solution of 1 g of 4-(2-methacryloyloxyethyloxy)-benzoic acid in 1 ml of NMP at 50° C. The reaction mixture is stirred at this temperature for 1 h, cooled, and mixed with 200 ml of water. The precipitate is filtered off, stirred again in 30 ml of methanol at room temperature, filtered off from the mother liquor and dried under vacuum. The yield amounts to 1.2 g. M.p. 194° C. λₘₐₓ=378 nm (DMF). ε=37000 l/(mol-cm).

### Example 2

### Production of the Homopolymers

7.5 g of monomer 1.1 and 0.15 g of 2,2′-azoisobutyric acid dinitrile were stirred in 70 ml of DMF in argon atmosphere for 24 h at 70° C. The polymer is precipitated out by pouring of the solution into 200 ml of water and purified by boiling up in methanol.

### Example 3

### Production of the Copolymers

0.8 g of monomer 1.1, 0.632 g of monomer 1.2 and 0.03 g of 2,2′-azoisobutyric acid dinitrile were stirred in 15 ml of DMF in argon atmosphere for 24 h at 70° C. The copolymer is precipitated out by pouring of the solution into 200 ml of water and purified by boiling up in methanol.

The mixed polymers according to the invention may be used excellently for the production of optical elements and stores, which are used preferably for the storage of data, wherein particularly preferably holography is used.

This is justified by the fact that very good information may be inscribed into the optical element by means of a laser beam.

The preferred subject-matter of the application is high-volume stores containing at least one mixed polymer according to the invention, which possess a transilluminated thickness of ≧0.1 mm, preferably ≧0.5 mm, particularly preferably ≧1.0 mm, most particularly preferably between 1 mm and 1 cm.

The production of high-volume stores in the form of films, sheets, plates and cuboids is possible without cumbersome orientation methods with the use of external fields and/or surface effects being required. They may be applied to substrates by means of spin coating, dipping, pouring or other coating methods easy to master technologically, brought between two transparent plates by pressing or inflow, or simply prepared as a self-supporting material by pouring or extruding. Such films, sheets, plates and cuboids may be produced by abrupt cooling, i.e. by means of a cooling rate of >100 K/min, or by rapid extraction of the solvent also out of liquid-crystalline polymers or oligomers which contain structural elements in the sense described.

The layer thickness is ≧0.1 mm, preferably ≧0.5 mm, particularly preferably ≧1 mm. A particularly preferred preparation method for layers in the millimetre range is represented by the injection moulding method. In this the polymer melt is pressed through a nozzle into a forming support, from which it may be removed after the cooling. The subject-matter of the application is also high-volume stores which are protected against mechanical damage by a protective layer.

The method of holographic data storage is described for example in LASER FOCUS WORLD, NOVEMBER 1996, p. 81 ff.

During the writing of a hologram the polymer films described above are irradiated by two coherent laser beams of a wavelength which produces the required light-induced reorientations. The one beam, the object beam, contains the optical information to be stored, for example the intensity curve which results from the passage of a light beam through a two-dimensional, chessboard-type pixel structure (data side). In principle, however, there may be used as the object beam, light which is diffracted, scattered or reflected from any optional two- or three-dimensional object. On the storage medium the object beam is caused to undergo interference with the second laser beam, the reference beam, which is in general a level or circular wave. The resulting interference pattern is impressed in the storage medium as a modulation of the optical constants (refractive index and/or absorption coefficient). Said modulation traverses the whole of the irradiated area, in particular the thickness of the storage medium. If now the object beam is blocked off and the medium is illuminated solely with the reference beam, the modulated storage medium functions as a kind of diffraction grating for the reference beam. The intensity distribution resulting from the diffraction corresponds to the intensity distribution which is issued from the object to be stored, so that it may no longer be distinguished whether the light comes from the object itself, or whether it results by virtue of the diffraction of the reference beam.

Various multiplex methods may be used for the storage of various holograms at a sample position: wavelength multiplexing, shift multiplexing, phase multiplexing, peristrophic multiplexing and/or angular multiplexing. With angular multiplexing the angle between the storage medium, in which a hologram has been stored under the current angles, and the reference beam is changed. From a certain change in angle onwards the original hologram disappears (Bragg mismatch): the incident reference beam may no longer be deflected by the storage medium for the reconstruction of the object. The angle from which this occurs depends critically on the thickness of the storage medium (and on the modulation of the optical constants which is produced in the medium): the thicker the medium, the smaller is the angle through which the reference beam must be changed.

In said new angular configuration a further hologram may be inscribed. The reading out of said hologram functions again in precisely the same angular configuration between storage medium and reference beam as it was written in.

Several holograms may therefore be inscribed at the same point of the storage medium by successive changing of the angles between medium and writing beams

The application provides all the polymers, methods and uses described in the claims.

The application provides a method for producing optical elements and storage elements, preferably holographic high-volume stores, by injection moulding.

The application provides a method for producing optical elements and storage elements, preferably holographic high-volume stores, by injection moulding, wherein in addition the moulding is polished.

A polishing of the mouldings takes place until such time as the wave-front distortion and the surface phenority is better than

$$\frac{λ}{10} .$$

The wave-front distortion is determined by the imaging of the moulding onto e.g. a CCD camera during the exposure of the latter to a beam of the writing laser of the wavelength λ.

The application provides a method for producing optical elements and storage elements, preferably high-volume holographic stores, by injection moulding, wherein in addition a transparent protective layer is applied.

The application provides optical elements and stores, preferably high-volume stores, particularly preferably high-volume holographic stores, according to the invention.

### EXAMPLES

### Example 4

### Sample Preparation Polymer Mixture B1

Polymer mixture B1 is a mixture between a polymer

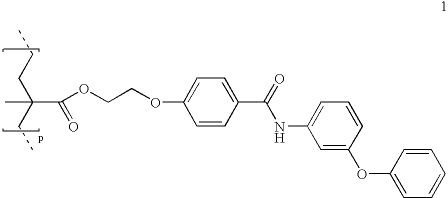

and a polymer of formula 2

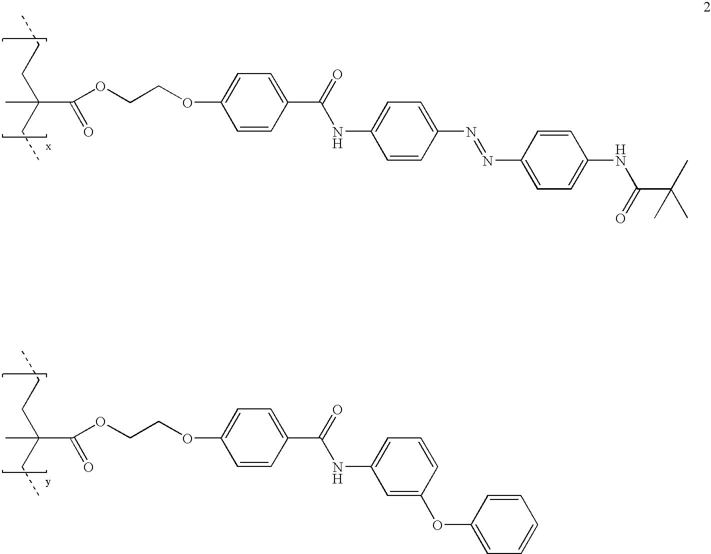

After the production, both polymers are mixed in the solid phase in such a way that the mean concentration of the azobenzene unit x in the mixture amounts to 1 mole % (referred to the sum x+y+p). The mixture is heated to 180° C. for stripping under vacuum. In so doing it turns into the liquid phase. In said phase the mixture may be pressed between 2 glass platelets. To this end a polymer drop of the polymer is placed on a glass substrate (size: 2.5 cm×2.5 cm). At the edge of the glass substrates are located thin PET plastic strips. A further glass substrate is placed on the polymer drop. A heavy metal weight is applied to the upper covering glass and serves as a pressing weight. The glass substrate-polymer-glass substrate sandwich is stored under vacuum for approx. 1 hour at 180° C. After the pressing and cooling of the sample the thickness of the glass-polymer-glass sandwich is measured: this results in a thickness of the polymer film of 137 μm. The film is optically transparent and non-scattering. At a wavelength of 532 nm an optical density of the polymer of OD (532 nm)=0.15 is measured with a UV/VIS spectrometer.

### Example 5

### Sample Preparation Polymer Mixture 2

After the production the polymer mixture B2 of formula 2 with an azobenzene concentration x=1 mole % is heated to 180° C. for stripping under vacuum. The further sample preparation takes place as in Example 1. After the pressing under vacuum a film thickness of 156 μm is obtained. At a wavelength of 532 nm an optical density of the polymer of OD (532 nm)=0.15 is measured with a UV/VIS spectrometer.

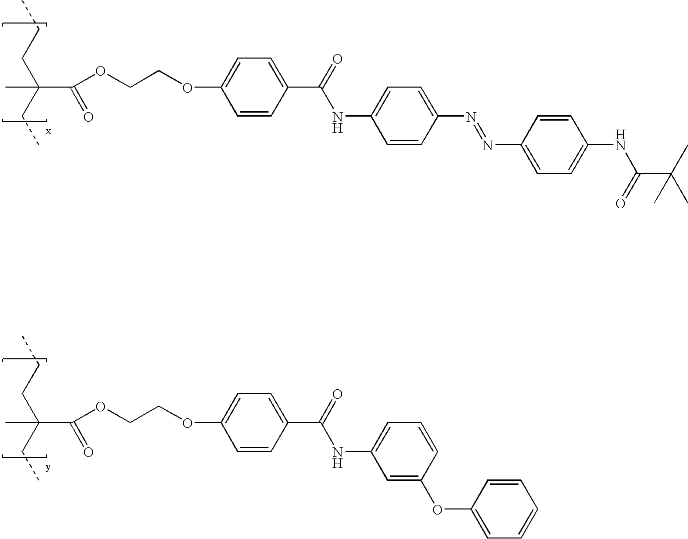

### Example 6

### Holographic Investigations on Polymer Mixtures B1 and B2 from Examples 1 and 2

In a holographic experiment a hologram of a data mask with 256×256 data points is recorded. The wavelength of the laser used amounts to λ=532 nm. The power density of the object beam at the sample site amounts to 2.8 mW/cm², the power density of the reference beam amounts to 134.3 mW/cm². A holographic contrast ratio m of m=0.28 is calculated from this. The exposure time with the two writing lasers amounts to 60 seconds in each case. Thereafter the holograms are read out with the reference beam with the object beam blocked off for 5 milliseconds. The diffraction efficiency η=I_{outg}/I_{inc} is calculated from the ratio of the incident light output I_{inc} of the reference beam and the intensity I_{outg} measured at the detector (in this case CCD camera) There may be derived from said quantity the material-specific size (η)^{1/2} (thickness), which is proportional to the light-induced refractive index modulation. The light sensitivity S of the material may be determined further from the development over time of the diffraction efficiency as the ascent of the holographic growth curve:

$$S = \frac{\partial \sqrt{η1}}{\partial Ed}$$

∂ a represents the derivation, E is the consumed writing energy (writing output x exposure time) and d represents the thickness of the samples.

The following table compares the measured results for polymer 1 and polymer 2.

| | Thickness d | OD @ | | (ηₘₐₓ)^{½}/d | S |
|---|---|---|---|---|---|
| Polymer | (μm) | λ_{write} | η | (μm⁻¹) | (cm/J) |
| Polymer | 137 | 0.15 | 7 × 10⁻⁵ | 6.11 × 10⁻⁵ | 0.089 |
| mixture 1 | | | | | |
| Polymer | 156 | 0.15 | 5 × 10⁻⁶ | 1.43 × 10⁻⁵ | 0.024 |
| mixture 2 | | | | | |

The table shows that the polymer mixture B1 both permits a higher diffraction efficiency Tq, and hence a higher refractive index modulation, and is more light-sensitive, i.e. possesses a higher S value.

### Example 7

### Turbidity Tests on Polymer Mixtures

For the quantitative analysis of the miscibility of various polymers, light scatter experiments are carried out on 1:1 mixtures of the following polymers. Polymer mixture B3 is a 1:1 mixture of a polymer of formula 3

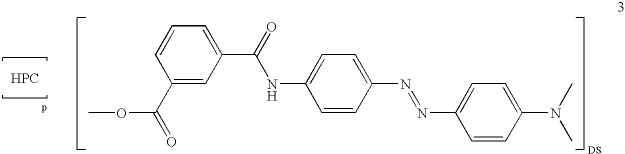

and a polymer of formula 4

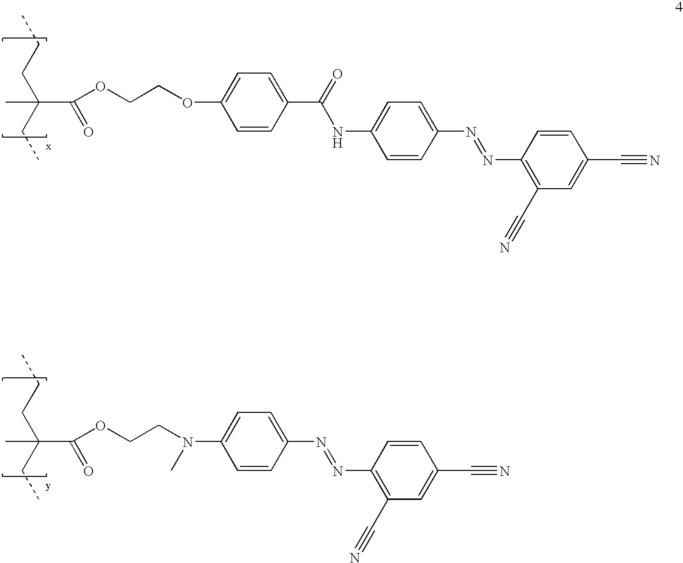

Polymer mixture B4 is a 1:1 mixture of a polymer of formula 3 (p=3000) and a polymer 5

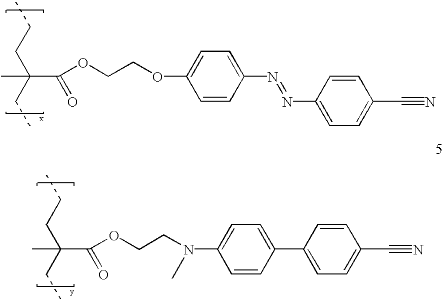

For the production of the polymer mixture the respective constituents are dissolved in THF in equal proportions by weight and applied to glass substrates by means of spin coating. Films with a thickness of approx. 1 μm are obtained.

There is given as the quantitative measured variable in turbidity tests the so-called haze value. Said value represents the proportion of the scattered transmitted light referred to the total amount of light transmitted.

$$Haze = \frac{scattered light ( transmission )}{total transmission}$$

Scattering or turbidity of the polymers occurs in the case of the mixtures when the separated phases possess an expansion in the area of the light wavelength. In order to allow for the absorption differences of the polymer films, the measurements are performed spectrally. It must be borne in mind that in the blue-green region of the spectrum the scattered light is also already absorbed in the sample because of the high absorption of the sample and does not contribute to the scattered light measured. This means in concrete terms that because of the self-absorption of the chromophores in the blue-green region of the spectrum the haze values have to be carried out in a region of the spectrum which lies outside the absorption bands of the chromophore systems investigated, in this case at wavelengths greater than 630 nm.

The turbidity value of polymer mixture B3 lies above the entire green/red region of the spectrum at haze≈0.3, while the polymer mixture B4 delivers haze values of between 4 and 8.5. The haze value at λ=630 nm may be taken as a reference, since at said wavelength the films used have a comparable total absorption: the haze value of polymer mixture B4 is greater by a factor of 20 than the haze value of polymer mixture B3.

This emphasises the fact that because of the similarity of the side chains in the individual components of polymer mixture B3 (3 core components respectively) a homogeneous mixture takes place, while in the case of polymer mixture B4 the mixture does not take place perfectly, inasmuch as phases of an expansion in the area of the light wavelength form, which must be regarded as the cause of the scattering.

1. A mixed polymer, characterised in that it consists of
at least one polymer (A) having at least 10 repeat units with the general formula (CI) 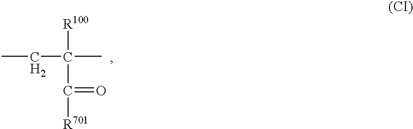
where
R¹⁰⁰ represents hydrogen or methyl and
R⁷⁰¹ represents —O—R⁸⁰¹, where
R⁸⁰¹ represents for hydrogen or C₁-C₈ linear or branched-chain alkyl without photoisomerisable groups, preferably methyl, ethyl, propyl, n-butyl, particularly preferably methyl, and
at least one polymer (B) having at least 3 repeat units with the general formula (CII) 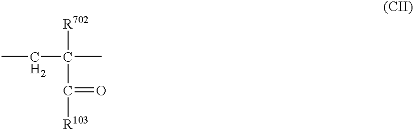
where
R⁷⁰² represents hydrogen or methyl and
R¹⁰³ for [-S-T-Q-P] and where P represents A and/or M,
where however a polymer (B) is always contained in which P represents A,
where the side-chains branching off from the main chain, of the formula S-T-Q-P with P=A (dye group), M (mesogen), are governed by the following definitions:
S-T-Q-P=S¹-T¹-Q¹-A
S-T-Q-P=S²-T²-Q²-M
where
S¹, S² signify independently of one another the atoms O, S or the group NR¹,
R¹ signifies hydrogen or C₁-C₄ alkyl,
T¹, T² signify independently of one another the group (CH₂)ₙ, which may optionally be interrupted by —O—, —NR¹— or —OSiR¹₂O— and/or substituted by methyl or ethyl,
n signifies the numbers 2, 3 or 4,
Q¹, Q² a divalent group,
A a unit which may absorb electromagnetic radiation and
M a polerisable aromatic group having at least 12 π-electrons.

2. A mixed polymer according to claim 1, characterised in that at least 10 repeat units are contained in the polymer (A).

3. A mixed polymer according to claim 1 and/or 2, characterised in that at least 3 repeat units are contained in the polymer (B).

4. A mixed polymer according to one or more of claims 1 to 3, characterised in that more than one polymer (A) and/or polymer (B) is contained, wherein however a polymer (B) is always contained, in which P represents A.

5. A mixed polymer according to one or more of claims 1 to 4, characterised in that the ratio of the sum of the monomers of the polymer (B) to the sum of the monomers of the polymer (A) lies between 1:1 and 1:10 000.

6. A mixed polymer according to one or more of claims 1 to 5, characterised in that polymer (A) contains methyl methacrylate units.

7. A mixed polymer according to one or more of claims 1 to 6, characterised in that polymer (B) contains at least two different monomers with the general formula [-S-T-Q-P], wherein at least one of said monomers bears a photoisomerisable group (A).

8. A mixed polymer according to one or more of claims 1 to 7, characterised in that polymer (B) contains a monomer in which the photoisomerisable group (A) is an azo group.

9. A mixed polymer according to one or more of claims 1 to 8, characterised in that the photoisomerisable group (A) has the structure (CIV) 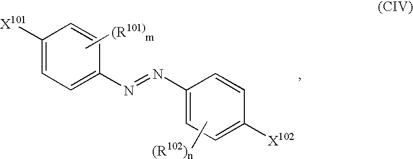
where
R¹⁰¹ and R¹⁰² represent independently of one another hydrogen or a nonionic substituent,
m and n represent independently of one another a whole number from 0 to 4, preferably 0 to 2,
X¹⁰¹ represents the linkage with S¹⁰¹T¹⁰¹Q¹⁰¹, i.e. X¹⁰¹ has the meaning
X^{101′}, where X^{101′} is linked to the Q with the 2nd valency,
X¹⁰² signifies X^{102′}—R¹⁰⁴,
X^{101′} and X^{102′} represent a direct bond, —O—, —S—, —(N—R¹⁰⁵)—, —C(R¹⁰⁶R¹⁰⁷)—, —(C═O), —(CO—O)—, —(CO—NR¹⁰⁵)—, —(SO₂)—, —(SO₂—O—)—, —(SO₂—NR¹⁰⁵)—, —(C═NR¹⁸)— or —(CNR¹⁸-NR¹⁵)—,
R¹⁰⁴, R¹⁵ and R¹⁸ represent independently of one another hydrogen, C₁- to C₂₀-alkyl, C₃- to C₁₀-cycloalkyl, C₂- to C₂₀-alkenyl, C₆- to C₁₀-aryl, C₁- to C₂₀-alkyl-(C═O)—, C₃- to C₁₀-cycloalkyl-(C═O)—, C₂- to C₂₀-alkenyl-(C═O)—, C₆- to CIO-aryl-(C═O)—, C₁- to C₂₀-alkyl-(SO₂)—, C₃- to C₁₀-cycloalkyl-(SO₂)—, C₂- to C₂₀-alkenyl-(SO₂)— or C₆- to C₁₀-aryl-(SO₂)— or
X¹⁰²—R¹⁰⁴ may represent hydrogen, halogen, cyano, nitro, CF₃ or CCl₃,
R¹⁰⁶ and R¹⁰⁷ represent independently of one another hydrogen, halogen, C₁- to C₂₀-alkyl, C₁- to C₂₀-alkoxy, C₃- to C₁₀-cycloalkyl, C₂- to C₂₀-alkenyl or C₆- to C₁₀-aryl,
S¹⁰¹ signifies the atoms O, S or the group NR¹⁰⁹,
R¹⁰⁹ signifies hydrogen or C₁-C₄-alkyl,
T¹⁰¹ signifies the group (CH₂)ₓ, which may optionally be interrupted by —O—, —NR¹⁰⁹— or —OSiR¹⁰⁹₂O— and/or substituted by methyl or ethyl,
x signifies the numbers 2, 3 or 4,
Q¹⁰¹ signifies Z¹⁰¹, Z¹⁰² or the group -Z¹⁰¹-X¹⁰⁰-Z¹⁰²-, where
Z¹⁰¹ and Z¹⁰² signify independently of one another the groups —S—, —SO₂—, —O—, —COO—, —OCO—, —CONR¹⁰⁹—, —NR¹⁰⁹CO—, —NR¹⁰⁹—, —N═N—, —CH═CH—, —N═CH—, —CH═N— or the group —(CH₂)_{y}— with y=1 or 2 and
X¹⁰⁰ signifies a 5- or 6-member cycloaliphatic, aromatic or heterocyclic ring, for the case Z¹⁰¹=—COO— or —CONR¹⁰⁹— a direct bond or the group —(CH═CH)_{y}—,
where y has the meaning given above.

10. A mixed polymer according to one or more of claims 1 to 9, characterised in that the monomers which bear a photoisomerisable group possess the formula (CV) 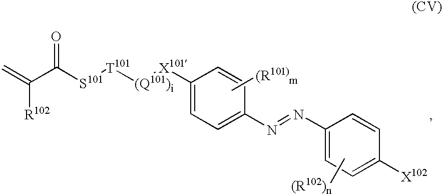
where
R¹⁰² represents hydrogen or methyl and
the other groups have the meaning given above.

11. A mixed polymer according to claim 10, wherein the monomers which bear photoisomerisable groups are selected from the structures

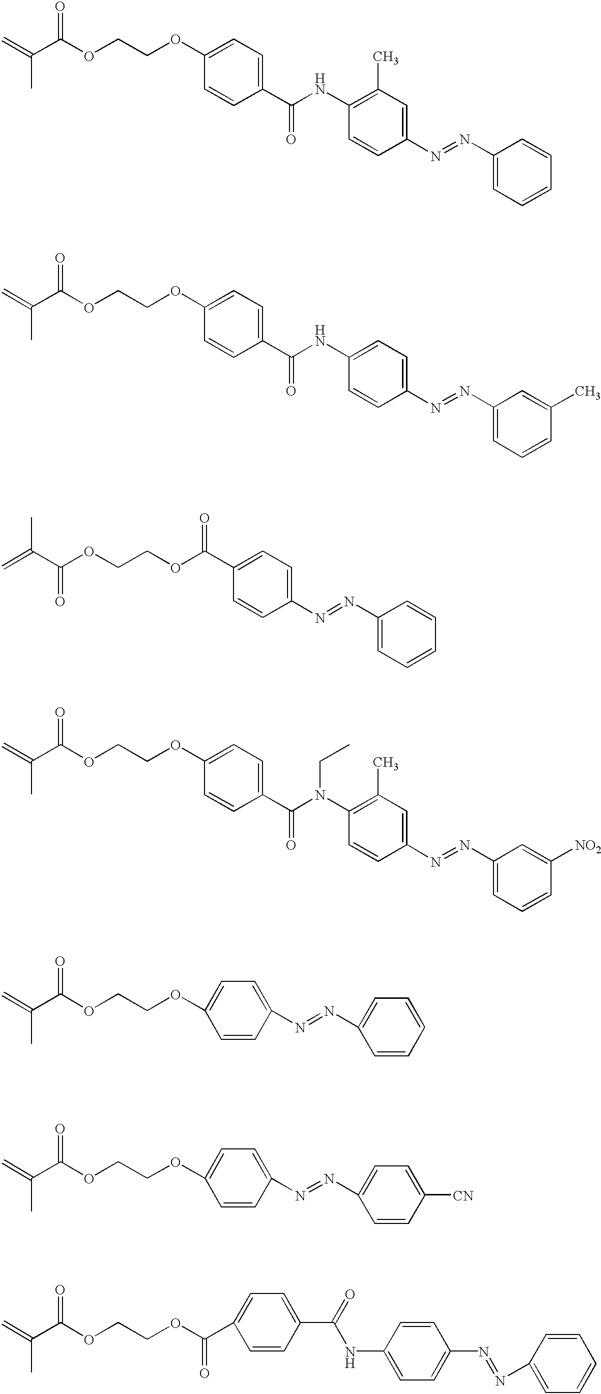

12. A mixed polymer according to one or more of claims 1 to 11, characterised in that the polarisable aromatic groups M correspond to the formula (CVI) 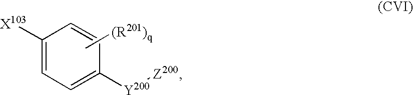
where
Z²⁰⁰ represents a group with the formulae 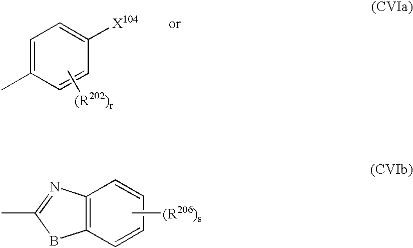
where
B represents O, S or N—C₁- to C₄-alkyl,
X¹⁰³ represents —X^{103′}-(Q¹⁰²)ⱼ-T¹⁰²-S¹⁰²—,
X¹⁰⁴ represents X¹⁰⁴—R²⁰³,
X^{103′} and X^{104′} represent independently of one another a direct bond, —O—, —S—, —(N—R²⁰⁵)—, —C(R²⁰⁶R²⁰⁷)—, —(C═O)—, —(CO—O)—, —(SO₂)—, —(SO₂—O)—, —(SO₂—NR²⁰⁵)—, —(C═NR²⁰⁸)— or —(CNR²⁰⁸—NR²⁰⁵),
R²⁰⁵, R²⁰⁸ and R²⁰³ represent independently of one another hydrogen, C₁- to C₂₀-alkyl, C₃- to C₁₀-cycloalkyl, C₂- to C₂₀-alkenyl, C₆- to C₁₀-aryl, C₁- to C₂₀-alkyl-(C═O)—, C₃- to C₁₀-cycloalkyl-(C═O)—, C₂- to C₂₀-alkenyl-(C═O)—, C₆- to C₁₀-aryl-(C═O)—, C₁- to C₂₀-alkyl-(SO₂)—, C₃- to C₁₀-cycloalkyl-(SO₂)—, C₂- to C₂₀-alkenyl-(SO₂)— or C₆- to C₁₀-aryl-(SO₂)— or
X^{104′}—R²⁰³ may represent hydrogen, halogen, cyano, nitro, CF₃ or CCl₃,
R²⁰⁶ and R²⁰⁷ represent independently of one another hydrogen, halogen, C₁- to C₂₀-alkyl, C₁- to C₂₀-alkoxy, C₃- to C₁₀-cycloalkyl, C₂- to C₂₀-alkenyl or C₆- to C₁₀-aryl,
Y²⁰⁰ represents a single bond, —COO—, OCO—, —CONH—, —NHCO—, —CON(CH₃)—, —N(CH₃)CO—, —O—, —NH— or —N(CH₃)—,
R²⁰¹, R²⁰², R²⁰⁶ represent independently of one another hydrogen, halogen, cyano, nitro, C₁- to C₂₀-alkyl, C₁- to C₂₀-alkoxy, phenoxy, C₃- to C₁₀-cycloalkyl, C₂- to C₂₀-alkenyl or C₆- to C₁₀-aryl, C₁- to C₂₀-alkyl-(C═O)—, C₆- to C₁₀-aryl-(C═O)—, C₁- to C₂₀-alkyl-(SO₂)—, C₁- to C₂₀-alkyl-(C═O)—O—, C₁- to C₂₀-alkyl-(C═O)—NH—, C₆- to C₁₀-aryl-(C═O)—NH—, C₁- to C₂₀-alkyl-O—(C═O)—, C₁- to C₂₀-alkyl-NH—(C═O)— or C₆- to C₁₀-aryl-NH—(C═O)—,
q, r and s represent independently of one another a whole number from 0 to 4, preferably 0 to 2,
Q¹⁰² represents a —O—, —S—, —(N—R²⁰⁵)—, —C(R²⁰⁶R²⁰⁷)—, —(C═O)—, —(CO—O)—, —(CO—NR²⁰⁵)—, —(SO₂)—, —(SO₂—O—)—, —(SO₂—NR²⁰⁵)—, —(C—NR²⁰⁸)—, —(CNR²⁰⁸—NR²⁰⁵)—, —(CH₂)ₚ—, p- or m-C₆H₄— or a divalent group with the formulae 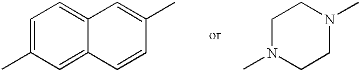
j represents a whole number from 0 to 4, where for j>1 the individual Q¹⁰² may have different meanings,
T¹⁰² represents —(CH₂)ₚ—, where the chain may be interrupted by —O—, —NR²⁰⁹— or —OSiR²²⁰₂O—,
S¹⁰² represents a direct bond, —O—, —S— or —NR²⁰⁹—,
p represents a whole number from 2 to 12, preferably 2 to 8, in particular 2 to 4,
R²⁰⁹ represents hydrogen, methyl, ethyl or propyl and
R²²⁰ represents methyl or ethyl.

13. A mixed polymer according to one or more of claims 1 to 12, characterised in that the monomers which have a grouping M exhibiting form anisotropy possess the formula (CVII) 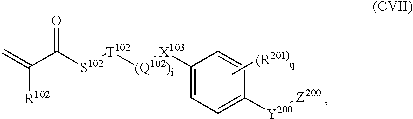
where
R¹⁰² represents hydrogen or methyl and
the other groups possess the meanings given above.

14. A mixed polymer according to claim 13, wherein monomers which bear the groups exhibiting form anisitropy (M) are selected from the structures

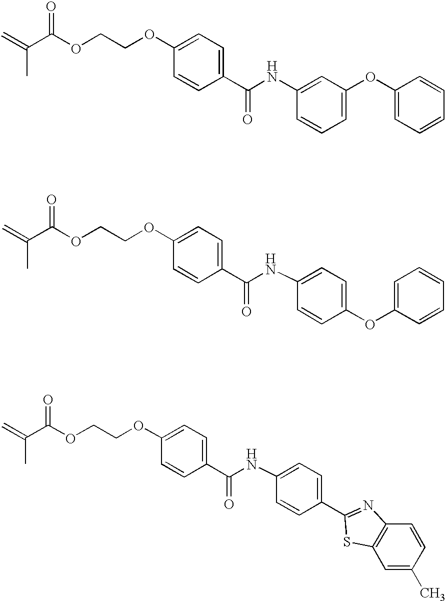

15. A mixed polymer according to one or more of claims 1 to 15, characterised in that the monomers of formula (CV) and of formula (CVII) are used in the ratio 1:1 to 1:30.

16. A mixed polymer according to one or more of claims 1 to 16, characterised in that it has an optical density ≦2.

17. A method for producing the mixed polymers according to one or more of claims 1 to 17, wherein the polymers (A) and (B) are produced by radical polymerisation and the mixed polymers are produced by mixing of said individual polymers in the desired quantitative ratios with heating to above the glass transition temperature.

18. Use of the mixed polymers according to one or more of claims 1 to 18 for producing optical elements and storage elements, preferably high-volume stores.

19. Use of the mixed polymers according to claim 19, characterised in that the optical element is used for the storage of data.

20. Use of the mixed polymers according to one or more of claims 19 to 20, characterised in that the optical element or storage element, preferably high-volume store, is used for the storage of data by holography.

21. Use of the mixed polymers according to one or more of claims 19 to 21, characterised in that information is inscribed into the optical element and/or store by means of a laser beam.

22. Store, preferably high-volume store, containing at least one mixed polymer according to one or more of claims 1 to 18, wherein the latter has a transilluminated thickness of ≧0.1 mm.

23. Method for producing optical elements and storage elements, preferably high-volume stores, by injection moulding according to one or more of the preceding claims.

24. Method according to claim 24, wherein in addition the moulding is polished.

25. Method according to claim 24 and/or 25, wherein in addition a transparent protective layer is applied.

26. Optical elements and stores according to one or more of claims 23 to 26.
